(19) United States
(12) Patent Application Publication
(10) Pub. No.: US 2004/0050032 A1
(43) Pub. Date: Mar. 18, 2004

(54) Expansible band for a watch or the like

(76) Inventor: Wing Cheuk Kwan, Hong Kong (HK)

Correspondence Address: BURNS DOANE SWECKER & MATHIS L L P, POST OFFICE BOX 1404, ALEXANDRIA, VA, 22313-1404, US

(21) Appl. No.: 10/242,450

(22) Filed: Sep. 13, 2002

(51) Int. Cl. F16G 13/00

(52) U.S. Cl. 59/80

(57) ABSTRACT

An expansible band (10) is disclosed as including a first band part (P), a second band part (Q₁, Q₂) and a third band part (R), each of the band parts including a number of inter-engaged link members (14A, 14B), in which each of the band parts (P, Q₁, Q₂, R) is movable between an expanded configuration and a stable contracted configuration, and the first band part (P) is releasably engaged with the second band part (Q₁, Q₂), and the second band part (Q₁, Q₂) is releasably engaged with the third band part (R).

### FIELD OF THE INVENTION

The present invention relates to an expansible band which may be used in the malting of watches, bracelets or the like.

### BACKGROUND OF THE INVENTION

Expansible bands are already known. One type of such bands is disclosed in U.S. Pat. No. 3,307,348, the contents of which are filly incorporated herein. As the band is expansible, it may be moved between an expanded configuration, e.g. when being pulled over the user's hand, and a filly contracted configuration, to which latter configuration the band is biased. When the band is worn by a user, the band is intended to remain in its stable, fully contracted configuration. The size of the band when in its fully contracted configuration should thus fit the size of the wrist of the user.

It is, of course, well known that different persons have different wrist sizes. However, in existing expansible bands, the length of the bands in their fully contracted configuration cannot be further reduced, without using specialized tools or by experienced technicians. Thus, for example, watch manufacturers cannot stock bands of one size only, but have to stock expansible bands of different sizes, e.g. large, medium and small, for fitting the wrist size of different users. This would create problems for stock management, and add to the cost.

It is thus an object of the present invention to provide an expansible band in which the aforesaid shortcoming is mitigated, or at least to provide a useful alternative to the trade and public.

### SUMMARY OF THE INVENTION

According to the present invention, there is provided an expansible band including at least a first, a second and a third band member, each including a plurality of inter-engaged link members, wherein at least said first band member is movable between an expanded configuration and a stable contracted configuration, wherein said first band member is releasably engaged with said second band member, and said second band member is releasably engaged with said third band member.

### BRIEF DESCRIPTION OF THE DRAWINGS

A preferred embodiment of the present invention will now be described, by way of an example only, with reference to the accompanying drawings, in which:

FIG. 1A is a side view of an expansible band according to the present invention;

FIG. 1B is a top view of the band shown in FIG. 1A;

FIG. 2A is a sectional view of a first type of link taken along the line A-A in FIG. 1A;

FIG. 2B is a sectional view of a second type of link taken along the line B-B in FIG. 1A;

FIG. 2C is a perspective view of the second type of link shown in FIG. 2B, with an engagement pin removed;

FIG. 2D is a side view of an engagement pin used in the band shown in FIG. 1A;

FIG. 2E is a perspective exploded view showing the engagement between the first and second type of links shown in FIGS. 2A and 2B respectively; and

FIGS. 3A to 3C show the manner in which the length of the band shown in FIG. 1A may be adjusted.

### DESCRIPTION OF THE PREFERRED EMBODIMENT

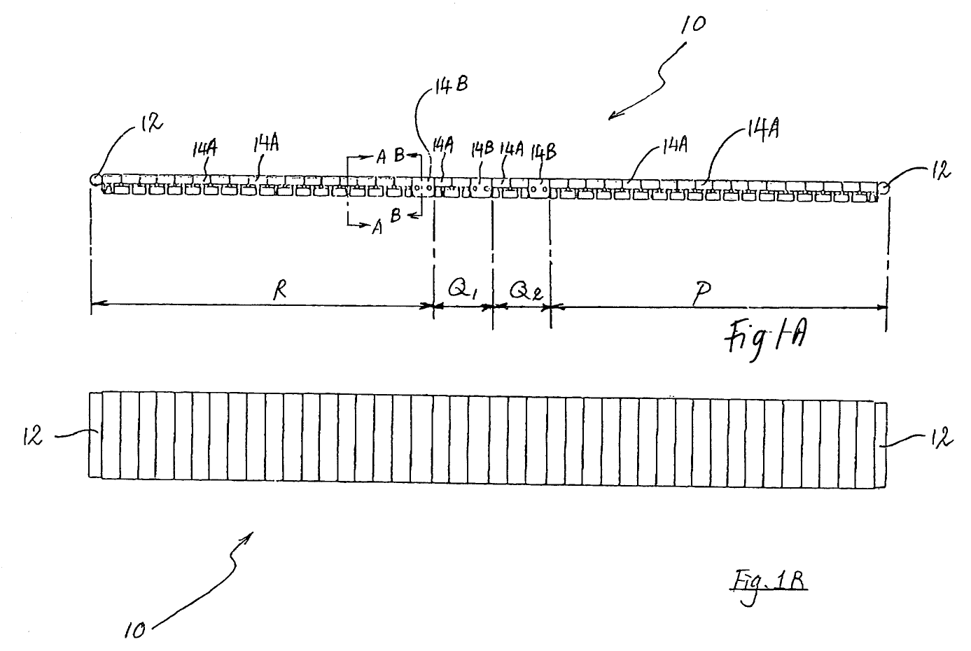

An expansible watch band according to a preferred embodiment of the present invention is shown in FIGS. 1A and 1B, generally designated as 10. At each end of the band 10 is provided with a crimped portion 12 adapted to be in engagement with a watch casing (not shown), in the conventional manner. The band 10 is made up of four band parts, P, Q₁, Q₂ and R, in which the band parts Q₁ and Q₂ are the same.

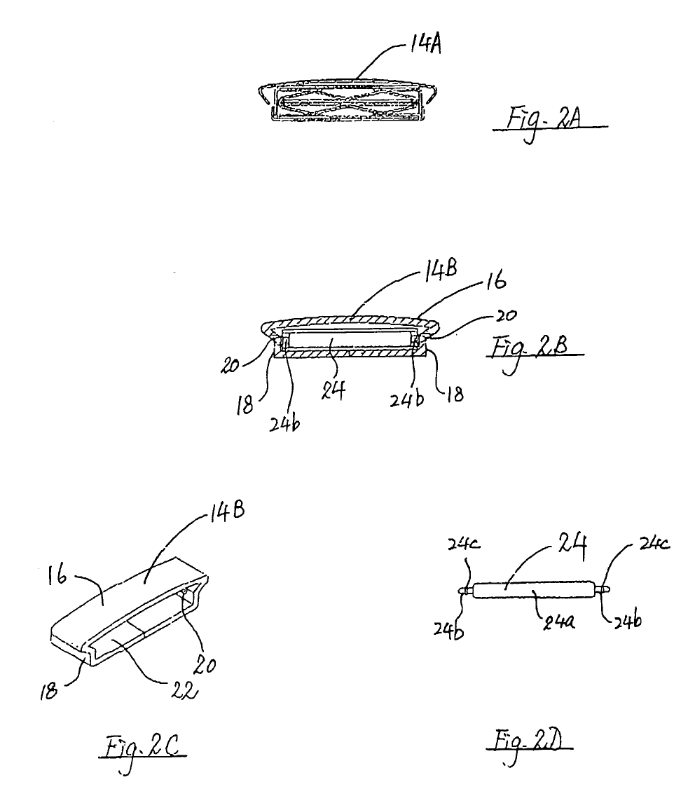

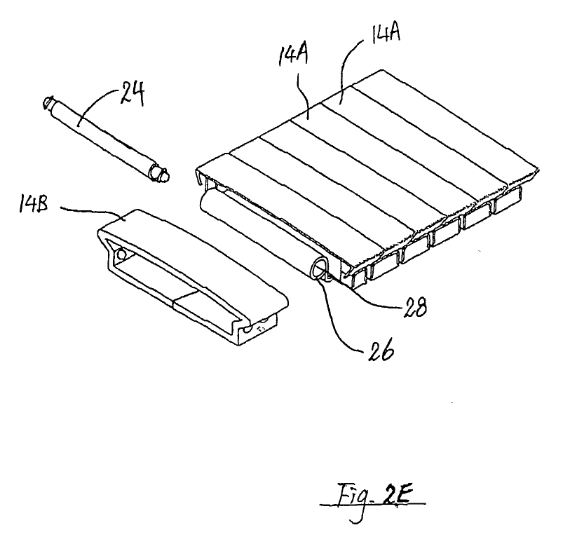

Each of the band parts P, Q₁, Q₂ and R is made up of a number of inter-engaging links. The band part P is made up of a number of links 14A inter-engaged with one another to allow the band part P to expand and contract in the conventional manner. In particular, because of the construction of the links 14A, the band part P is biased towards the contracted configuration, which is thus also the stable configuration. A cross sectional view of the link 14A is shown in FIG. 2A. As to the band parts Q₁ and Q₂, each is made up of a link 14B and a number of links 14A. In this example, the lengths of the band parts Q₁ and Q₂ are the same. It is of course possible for the lengths of the band parts Q₁ and Q₂ to be different, or to provide several of such band parts Q₁ and Q₂, to increase the freedom in adjusting the length of the band 10. Again, the band parts Q₁ and Q₂ are movable between an expanded configuration and a stable contracted configuration. Turning to the band part R, such is made up of a link 14B engaged with a number of links 14A, again allowing the band part R to expand and contract, in the conventional manner.

A cross section view of the link 14B is shown in FIG. 2B, and a perspective view thereof is shown in FIG. 2C. It can be seen that the link 14B has a slightly curved upper surface 16 and two opposite end walls 18. On each end wall 18 is formed two holes 20, of which only part of one is shown in FIG. 2C. The link 14B has a cavity 22 sized and configured to receive an engagement pin 24, a side view of which being shown in FIG. 2D. The engagement pin 24 has a central thicker portion 24a and two narrower end portions 24b. Each of the end portions 24b is movable axially relative to the central portion 24a between a retracted position and an extended position. The end portions 24b are biased towards the respective extended position by a spring (not shown) in the central portion 24a. The extent to which the end portions 24b may be moved towards the central portion 24a is governed by a respective narrow collar 24c extending radially from the respective end portion 24b. As shown in FIG. 2B, each of the end portions 24b of the engagement pin 24 is received respectively within a hole 20 on the end wall 18 of the link 14B.

FIG. 2E shows in more detail the manner in which the link 14A is engaged with the link 14B. At the link 14A adjacent to the link 14B, a crimped portion 26 is formed to provide a channel 28 for releasably receiving the engagement pin 24. The engagement pin 24 may thus be received within the link 14B for releasable engagement therewith.

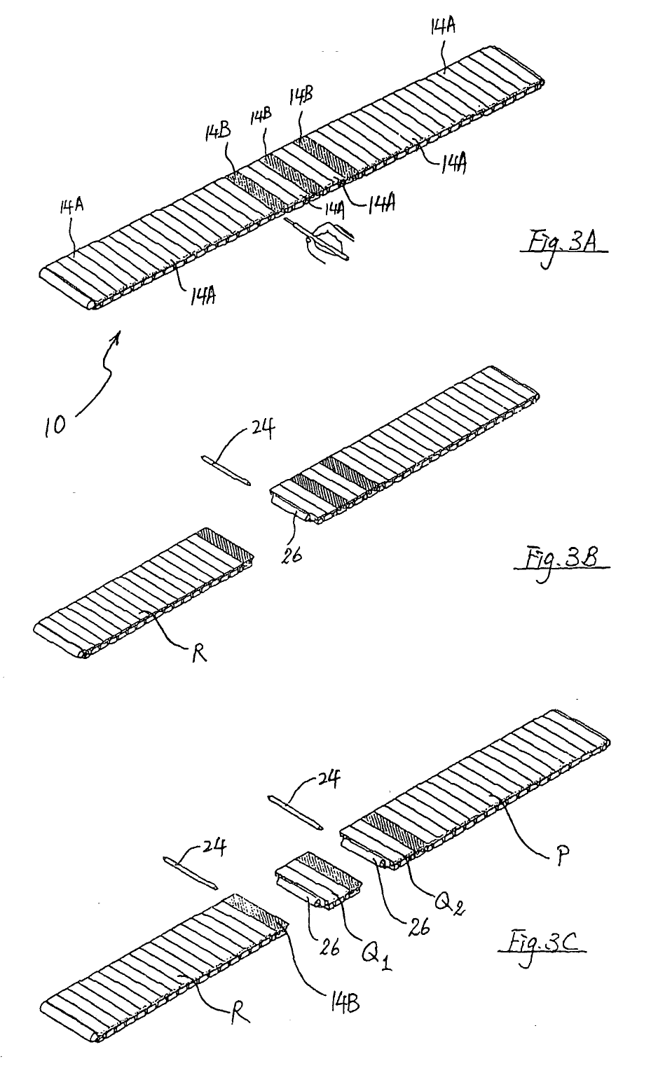

FIGS. 3A to 3C show the manner in which the length of the band 10 may be adjusted. In these figures, in order to enhance clarity, the links 14B are shown as hatched. It should however be appreciated that the outward appearance of the links 14B and 14A may be essentially identical to each other, to provide a homogeneous look.

As shown in FIG. 3A, a user may use an implement with a sharp end to act on one of the end portions 24b of the engagement pin 24, against the biasing force of the spring in the central portion 24a of the engagement pin 24, and to push the engagement pin 24 slightly sideward. The engagement pin 24, thus out of engagement with one of the holes 20 of the link 14B, will allow the band part R to be detached from the rest of the band 10, as shown in FIG. 3B. If necessary, the engagement pin 24 may also be detached from the crimped portion 26. In the same way, the engagement between the band parts Q₁ and Q₂ may be released, thus detaching the band part Q₁ from the band parts Q₂ and P, as shown in FIG. 3C.

The band parts Q₂ and P and the band part R may be releasably engaged with each other by having the engagement pin 24 received within the crimped portion 26 of the band part Q₂. One end portion 24b of the engagement pin 24 is then received within a hole 20 of the link 14B of the band part R Another end portion 24b of the engagement pin 24 is then pressed axially towards the central portion 24a to allow the engagement pin 24 to be wholly received within the cavity of the link 14B. When the engagement pin 24 is aligned with both the appropriate holes 20, the other end portion 24b will move to its extended position under the biasing force of the spring in the engagement pin 24 to engage the other hole 20, and thereby to engage the band part Q₂, and thus the band part P with which it is engaged, with the band part R.

If desired, e.g. to further reduce the length of the resultant band, the band part Q₂ may similarly be detached from the band part P, and the band parts P and R be releasably engaged with each other.

It can be seen that, by way of the arrangement in the present invention, the length of the band 10 may be easily adjusted, even by the end user, by using a very simple hand implement.

It should be understood that the above only illustrates and describes an example whereby the present invention may be carried out, and that modifications and/or alterations may be made thereto without departing from the spirit of the invention.

It should also be understood that various features of the invention which are, for brevity, described here in the context of a single embodiment, may be provided or separately or in any suitable sub-combination.

What is claimed is:

1. An expansible band including at least a first, a second and a third band member, each including a plurality of inter-engaged link members, wherein at least said first band member is movable between an expanded configuration and a stable contracted configuration, wherein said first band member is releasably engaged with said second band member, and said second band member is releasably engaged with said third band member.

2. A band according to claim 1 wherein said first band member is adapted to be releasably engaged with said third band member when said second band member is detached from said first and third band members.

3. A band according to claim 1 including a plurality of second band members.

4. A band according to claim 1 wherein said first band member is releasably engaged with said second band member via a resilient engagement member.

5. A band according to claim 4 wherein said resilient engagement member includes a pin member with at least an end part movable between a retracted and an extended position.

6. A band according to claim 5 wherein said end part is biased towards said extended position.

7. A band according to claim 5 wherein said resilient engagement member includes two end parts, each being movable between a retracted and an extended position.

8. A band according to claim 4 wherein said resilient engagement member is engaged with a channel member of said first band member.

9. A band according to claim 8 wherein said resilient engagement member is releasably engaged with said channel member.

10. A band according to claim 4 wherein said resilient engagement member is substantially wholly received within a link member of said second band member.

11. A band according to claim 10 wherein said resilient engagement member is engaged with an aperture on an end wall of said link member of said second band member.

12. A band according to claim 11 wherein said resilient engagement member is engaged with two apertures, each on a respective end wall of said link member of said second band member.

13. A band according to claim 12 wherein said link member of said second band member includes two pairs of apertures, each on a respective end wall thereof, whereby said link member of said second band member is engaged with two said resilient engagement members.

14. A band according to claim 1 wherein said second band member is releasably engaged with said third band member via a resilient engagement member.

15. A band according to claim 14 wherein said resilient engagement member includes a pin member with at least an end part movable between a retracted and an extended position.

16. A band according to claim 15 wherein said end part is biased towards said extended position.

17. A band according to claim 15 wherein said resilient engagement member includes two end parts, each being movable between a retracted and an extended position.

18. A band according to claim 14 wherein said resilient engagement member is engaged with a channel member of said second band member.

19. A band according to claim 18 wherein said resilient engagement member is releasably engaged with said channel member.

20. A band according to claim 14 wherein said resilient engagement member is substantially wholly received within a link member of said third band member.

21. A band according to claim 20 wherein said resilient engagement member is engaged with an aperture on an end wall of said link member of said third band member.

22. A band according to claim 21 wherein said resilient engagement member is engaged with two apertures, each on a respective end wall of said link member of said third band member.

23. A band according to claim 22 wherein said link member of said third band member includes two pairs of apertures, each on a respective end wall thereof, whereby said link member of said third band member is engaged with two said resilient engagement members.

24. A band according to claim 1 wherein said second band member is movable between an expanded configuration and a stable contracted configuration.

25. A band according to claim 1 wherein said third band member is movable between an expanded configuration and a stable contracted configuration.
